(19) United States
(12) Patent Application Publication
(10) Pub. No.: US 2014/0335746 A1
(43) Pub. Date: Nov. 13, 2014

(54) QUICK DISCONNECT BATTERY TERMINAL

(71) Applicant: C & C POWER, Carol Stream, IL (US)

(72) Inventors: N. William Conrardy, Elmhurst, IL (US); Eric Gach, Clarkston, MI (US)

(21) Appl. No.: 14/270,826

(22) Filed: May 6, 2014

Related U.S. Application Data
(60) Provisional application No. 61/821,476, filed on May 9, 2013.

(51) Int. Cl. H01R 4/24; H01R 43/048; H01R 43/02

(52) U.S. Cl. CPC H01R 4/24; H01R 43/02; H01R 43/048
USPC 439/884; 29/857; 29/860; 29/863

(57) ABSTRACT

A connector for use in a cable assembly is described. The connector has a tab or socket having a long tang portion. The tang portion of the connector may be bent with respect to the tab or socket portion and the tang portion captivate between a cable and a cable termination. The cable termination may be a crimpable lug or a clamp having a crimpable portion. When formed into a cable termination assembly and connected where the cable is connected in a current-carrying application, the connector provides a quick disconnect capability for a smaller gauge sensing wire attached to a complementary tab or socket.

This application claims the benefit of US provisional application No. 61/821,476, entitled “Quick Disconnect Battery Terminal, filed on May 9, 2013, which is incorporated herein by reference.

### TECHNICAL FIELD

This application may have relevance to battery systems where monitoring devices may be connected to a battery terminal or to other type of electrical terminal.

### BACKGROUND

Direct current (DC) power is needed for many types of telephone communication equipment, for control equipment used at electric utility substations, for computer data centers, and power plants, and other similar uses. The DC power may be supplied by a DC power source which may be supplied with AC power from an AC power source, such as the local power grid, or a generator and prime mover. Standby storage batteries are utilized as a backup DC power source when the DC power source either cannot supply all the power required by the components or when the AC power supply or other external power source is not available, as during a power failure at the local electric utility, or in the power distribution system. The period of time where such battery backup is required may be reduced by providing local diesel-electric or turbine-powered electric generators. However, during the time where other backup power sources are unavailable or when switching between alternative prime power sources, standby batteries are needed. Since the occurrence of power outages is normally infrequent, the condition of the batteries during the times when they are not actively providing the backup power may not be known.

A storage battery may be characterized as having an internal impedance, which may include resistive, inductive and capacitive components. When the battery is discharging, only DC is involved and the resistive component of the impedance may be of interest as the discharge current produces a voltage drop across the internal resistance of the battery in accordance with Ohm's law. Over the life of the battery the internal resistance may increase, at a rate determined by such factors as how many times the battery undergoes cycles of discharging and recharging, and other factors. The internal resistance of any cell will eventually increase to a value where the voltage drop across the effective internal resistance during discharge is so great that the battery can no longer deliver power at its rated capacity. Other defects in the battery, or aging of the battery, may also result in degradation of the capacity of a battery to perform its function.

When strings of batteries are used to increase the voltage being supplied or, in general, when batteries are connected in either series or parallel, the impedance of the overall string has an influence on the amount of energy that can be supplied. Other components of the physical assembly, including connecting links or cables, terminal connections and the like which can exhibit resistance, and whose characteristics may vary with time, due to such factors as corrosion and changes in contact pressure, also contribute to the resultant battery system status.

There are a variety of battery monitoring systems available. Typically these battery monitoring systems are configured so as to monitor each of the individual batteries in a battery string. Monitors may be configured so as to measure individual battery terminal voltages as a means of identifying defective batteries. Such monitoring systems require a direct connection to the batteries in the string being monitored for proper functioning.

The 2009 edition of the International Fire Code (available from the International Codes Council, Washington, D.C.), at section 608.3, requires that valve regulated lead-acid (VLRA) and lithium ion batteries be provided with a listed device or other approved method to preclude, detect and control thermal runaway. The requirements of this code are being adopted by local, state and national authorities.

Determining the operating condition of batteries of a battery string may comprise monitoring the overall performance of the battery string, and techniques for doing so are described, for example in U.S. Pat. No. 7,772,852, “Battery String Performance Measurement”, which is commonly assigned and which is incorporated herein by reference. Other monitoring techniques may measure characteristics of individual batteries of the battery string, or of individual batteries by measuring the voltage between the two external terminals of individual batteries. Since the voltage measurement is usually made with a high input impedance device, little current flows in the wires connecting the voltmeter to the battery terminals and the wires may be of a much smaller cross-section than the cables that carry the battery current. Such wires are more flexible and easier to route to the voltmeter. However, the disparity in size of the wires may make the connection of the two different gauges of wires to the same terminal difficult.

In an example, shown in FIG. 1, a partial view of two batteries 5 is shown with current carrying cables having crimp lug connections that are bolted to battery terminals. The terminal at the far right hand side 20 does not have a sensing connection. The terminal in the center 21 of the figure has a single tab (male) 155 sized and dimensioned to accept female push-on connector 31 that may be crimped to a flexible wire 33. Similar connectors 150 are used to make connections to printed circuit boards, and an example is shown in FIG. 2, however they are unsuitable for captivating to current carrying terminals as they cannot be suitably captivated to the terminal. The use of such connectors requires installation such that the flat shank, or tang 152, be pressed into a hole in the printed circuit board and make electrical contact with a printed circuit conductive trace on the board. The tab 155 is the male portion of the connector 150.

A push-on mating connector (female) 31 is shown in FIG. 1 (left hand side) attached to a smaller-gauge sensing wire 33 and mated with the tab 155 of a connector where the tab 155 is attached to a washer 34. The terminal on the far left hand side 22 of FIG. 1 has two tabs 155 for connecting to female push-on connectors 31. One of the tabs is shown mated with a push-on connector, and the other is not. This condition may occur when the connection is temporarily used for additional monitoring circuits, or where the terminal is installed so as to permit later installation of the monitoring devices. This could occur when the user installs third party monitoring equipment.

Each of the tabs 155 in FIG. 1 is formed so as to extend from a washer 34. The washer 34 is placed over the screw terminal 6 (not shown) of the battery 5 and captivated by a bolt 11 used to make the current-carrying connection by threading the bolt 11 through the washer and the hole 17 in the tab end 18 of the lug 15 which is captivated to current-carrying cable 10. A threaded post may also be used as a battery terminal and a nut used to captivate the lug 15 and the washer 34 having the tab 155 to the battery terminal. In a further alternative, the cable may be terminated in a clamp and the clamp affixed to a non-threaded post. However, in the latter instance a washer and lug are not used. Where the term “lug” is used, a clamp may be provided in place of the tab end of the lug. The term “lug” as used herein is intended to encompass the clamp end.

In an aspect, an manufacturer or installer may install, for example, two, one, or no tab terminals to each battery terminal. The overall height of the assembly of cables to a terminal would then have three possible heights, corresponding to the number of tab terminals installed, since each tab terminal has an associated washer thickness. When a bolt is used, three different bolt lengths may be needed so as to ensure that the bolt does not bottom out in the terminal hole and damage the battery before the appropriate torque is applied, or that the bolt is not too short and the internal threads may be overstressed or stripped. The difference in bolt lengths arising from the washer thickness is not substantial and the manual selection of bolts for the specific connection configuration creates a possibility of error.

The high-current-carrying cables 10 that connect the batteries in a battery string arrangement are often terminated in a crimp lug 15, as shown in FIG. 1 and in detail in FIG. 3. Since the cross-section of the cable may be large, so as to provide a low resistance path, the cable may be made up of a plurality of strands or conductors so as to provide some flexibility in bending and to reduce the effect of bending fatigue on the conductors. The crimp lug 15 may have an opening 16 sized and dimensioned to accept the cable 10, a barrel 19 that may be crimped or swaged to retain the cable 10 and create a low-resistance joint, a flat portion 18 having a hole 17 therein, and an opening 14 (optional) for use to flow solder into the barrel 19 to improve the connection to the cable 10.

An example of a cable 12 terminated at the left-hand end in a crimp lug 15, having insulation along the length and having an unterminated right-hand end showing an example structure of the cable is shown in FIG. 4.

It may be desirable for the tabs 155 to have specific rotational orientations with respect to each other when there are a plurality of tabs, or to the direction of the current-carrying cable and the lug 15. When the bolt 11 is being tightened, the relative friction between the washers 34 and the crimp flat portion 18 of the crimp lug 15 may cause an angular rotation of the components with respect to each other. Maintaining the appropriate alignment often requires a certain amount of trial and error and manipulation of the components as the fastener (bolt or nut) is being torqued. In addition to wearing plated surfaces, this is time consuming and often contributes to variations in final torque values. As such torque values and surface conditions contribute to the resistance of the connection, battery system performance may be affected.

The tabs and push-on connectors may be of variety of configurations For example, the terminals may meet the dimensional and performance requirements of the National Electrical Manufacturers Association specification number NEMA2-1982-(1988) and UL310.

### SUMMARY

A component that may be used in an electrical apparatus is disclosed, the component having a tab sized and dimensioned to mate with a push-on connector; and a tang having a length sufficient to enable the tang to be captivated between an electrical cable and an inner surface of a connecting terminal, which may be a crimpable lug, or a clamp.

For simplicity of description, the term “tab” is used to describe the portion of the component attached to the connecting terminal using the tang. As illustrated herein, the tab is a male component, and the connection is completed by pushing a socket onto the tab, the socket being connected, for example, to a sensing wire. The arrangement where the tab is a socket configuration component and the connection is completed by pushing a tab into the socket, where the tab is connected, for example, to a sensing wire is equally possible and the description and claims should be read as encompassing both configurations. That is, male and female styles of connector being interchanged. The connector that has a smaller gauge sensing wire attached and the mating portion of the connector component described here may meet industry standards as exist or may be developed for compatibility of components.

The component may be produced by, for example, from a sheet of metal. Either at the time of manufacture, before installation or during installation, a bend may be formed at the base of the tang where the tab is joined to the tang of from about 15 degrees to about 90 degrees so that the tab portion is available to mate with a correspondingly configured part. Alternatively, a plurality of bends in the tab portion may be used so that the bend at the base of the tab is about 90 degrees, and a second bend is made in the tab so as to position the tab at another angle with respect to the cable.

A pair of stubs may be provided near the base of the tab, spaced apart from the tang by, for example, a distance greater than a thickness of a wall of the connecting terminal.

When the tab component is installed so that the tang is captivated between an inside surface of the connecting terminal and the electrical cable, and the tang is bent by approximately 90 degrees to the tab, the stubs may be bent 90 degrees to the tang so that, the stubs are disposable opposite an outside surface of the shell of the lug and the tang is disposable opposite an inside surface of the shell of the lug.

Where the stubs are provided and the bend angle of top of the tab is not 90 degrees, a further bend may be provided between the tab and the stubs.

Where two tabs are provided, each of the tabs may be spaced apart and disposed parallel to each other and joined to the tang by a common metal surface.

In another aspect, a connector assembly is described, including a current carrying connector, a cable and a connector component captivated between the cable and the connector, The connector component has a tab sized and dimensioned to mate with a push-on socket, the tab having a tang with a length sufficient to be captivated between the cable and an inner surface of the current carrying conductor. The socket may be connected to a sensing wire.

In yet another aspect, a method of manufacturing a connector assembly is described, including: providing a connector component, current carrying connector and an electrical cable, where the connector component has a tab sized and dimensioned to mate with a push-on socket and a tang having sufficient length to be captivated between the electrical cable and an inner surface of the current carrying connector.

The connector assembly is effected by inserting a bare end of the electrical cable into a rear opening in the current carrying connector, the rear opening being at an opposite end from a portion of the current carrying connector formed so as to be suitable for captivation to an electrical terminal; inserting the connector component into the rear opening of the current carrying connector such that the tang is disposed between an inner surface of the current carrying component and the cable; and, captivating the electrical cable and the connector component to the current carrying connector. One or more bends may be formed in the component during manufacture or installation so as to orient the tab portion at a desired angle with respect to the axis of the cable.

The step of captivating the electrical cable and the connector component to the current carrying connector comprises at least one of crimping or swaging the outside of the current carrying connector at a portion containing the inserted electrical cable and connector component tang or, soldering the electrical cable and the tang to the inner surface of the current carrying connector.

### BRIEF DESCRIPTION OF THE DRAWINGS

FIG. 1 is a partial perspective view of a two storage batteries with current carrying cables and disconnectable sensing wires attached in various configurations (prior art);

FIG. 2 is an example of a printed circuit board connector that is unsuitable for captivating to a battery terminal (prior art);

FIG. 3 is an illustration of a lug that may be used to terminate a current-carrying cable so as to be attachable to a battery terminal (prior art);

FIG. 4 illustrates representative aspects of a current carrying cable (prior art);

FIG. 5A illustrates a quick disconnect connector suitable for captivating in an assembly with a lug and current carrying cable (shown in an unbent state) and FIG. 5B illustrates the quick disconnect connector where the tang is bent at a 90 degree angle with respect to the tab and shown positioned inserted into the rear of a lug, prior to insertion of the current carrying cable;

FIG. 6A shows a top view and FIG. 6B shows an end view of the quick disconnect connector of FIG. 5A in a bent configuration and lacking stubs;

FIG. 7A is a side cross-sectional view of an end of the current carrying cable and the quick disconnect connector inserted into the lug and FIG. 7B is an end view of the connector opening into which the current carrying cable can be inserted also showing the quick disconnect connector; and

FIG. 8 shows an example of the quick disconnect connector having two tabs, and a view of the connector where the tang is bent at 90 degrees to the tab and positioned in the rear opening of the lug.

### DETAILED DESCRIPTION

Exemplary embodiments may be better understood with reference to the drawings, but these examples are not intended to be of a limiting nature. Like numbered elements in the same or different drawings perform equivalent functions. When a specific feature, structure, or characteristic is described in connection with an example, it will be understood that one skilled in the art may effect such feature, structure, or characteristic in connection with other examples, whether or not explicitly stated herein.

A tab-ended terminal may be configured to be installed in the current cable terminal assembly, which may be a crimp lug 15, clamp or the like, by crimping or compressing a portion of the terminal distal from the tab end into the current cable terminal assembly at the time that the current cable terminal assembly is attached to the current cable. The current cable terminal assembly may be crimpable lug, a clamp, or the like. Such terminated cables may be either pre-made to specified lengths or configured as required with the current cable terminal assembly.

While this discussion is based on the tab (male) portion of the mating connector assembly being associated with the current terminal assembly, a socket (female) portion may be provided. The female portion of the connector assembly may be associated with the current terminal assembly. Where is more than one such terminal assembly, a female and a male portion may be part of the same assembly.

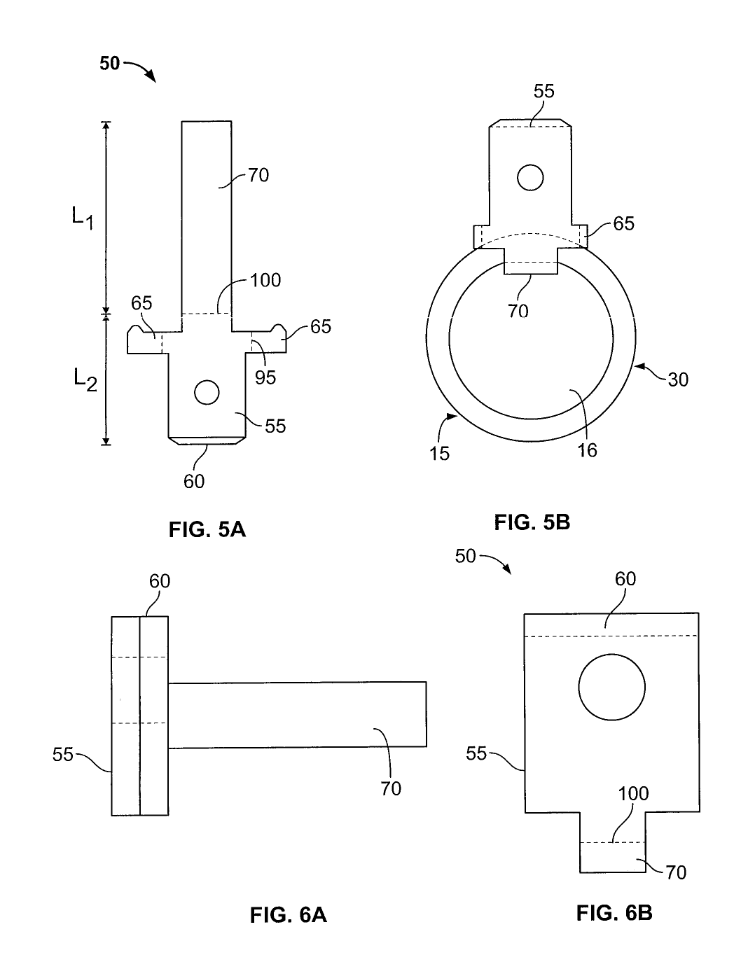

FIG. 5A shows an example of a tab component for use, for example, in a crimped lug current cable terminal assembly. The tab component 50 is shown in a plan view as it may appear after, for example, having been stamped out of a metal sheet, and may be partially finished by tumbling, plating, or the like. The tab connector 50 may be fabricated from brass, copper, steel, or the like, and may have a compatible plating to reduce the resistance of the connection and inhibit oxidation. A male tab portion 55 is sized and dimensioned to meet the specification requirements for mating with a push-on mating female connector. The complementary male-female configuration may also be used.

A chamfer 60 may be formed at the end of the tab portion 55 so as to facilitate the mating of the female connector. The dimensions chosen may merely be such that the mating end of the connector functions appropriately for the purpose, or to meet some industry specification.

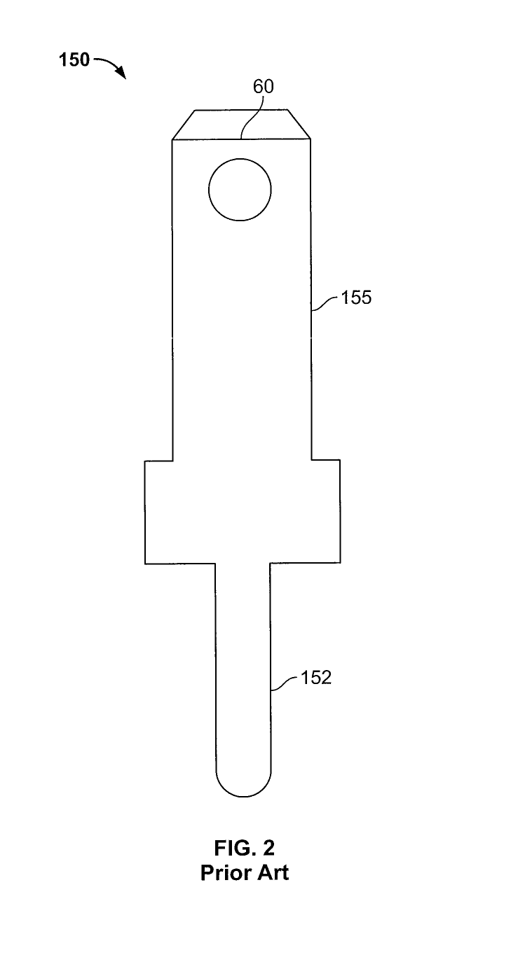

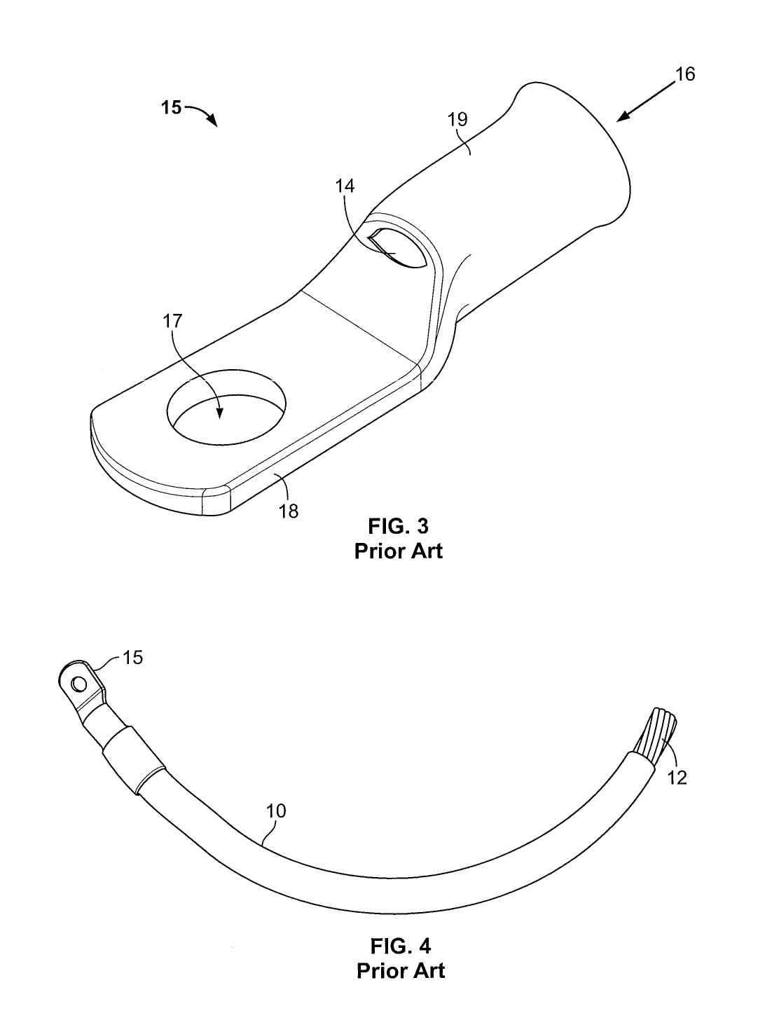

The connector 50 differs from the configuration of FIG. 2, for example, as the flat tang portion 70 may extend from the a base portion of the tab portion 55 and have a length L1 that is substantially longer than the stake end 152 of a standard PCB mount male terminal 155, when compared with the length of the tab portion, being sized and dimensioned to be compatible with the barrel portion 19 of the crimp lug 15. Moreover, the component 50 may be bent or be suitable for bending through an angle of, for example, 90 degrees at a position 100 between the tab 55 and the tang 70. When the component 50 is not bent or partially bent in the manufacturing process, a score line may be formed at the bend location 100 so as to facilitate bending.

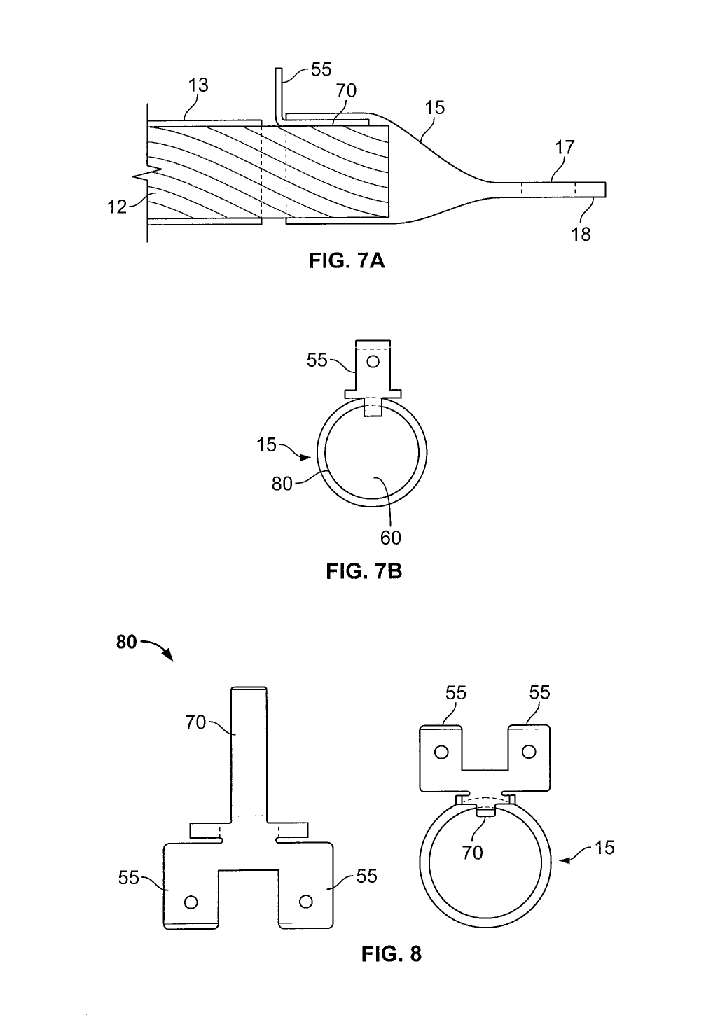

The flat tang portion 70 is intended to be inserted into the same opening 16 in the crimp lug 15 as the battery cable 12 (see FIG. 7), and captivated between the battery cable 12 and the inner circumference 80 of the lug 15 when the crimp connection is made. The attachment of the battery cable 12 to the lug 15 may be accomplished by, for example, crimping, soldering, or both.

At the time of manufacture, or at a later date, the flat tang portion 70 may be bent at a position of approximately 90 degrees with respect to the tab 55 near the base of the tab 55, so that the tab 55 will extend at an angle from the axial direction of the cable 112 to permit the mating of the tab 55 with a push-on connector. The selection of the bend angle and the location of the bend may vary with the application and the diameter of the battery cable 12. In an example, nominal bend angle of about 50 degrees may prove generally suitable. However, there is no intent to limit the bend angle and the angle may range from greater than 90 degrees to perhaps 15 degrees.

In another example, FIG. 6 illustrates a tab component 50 that has been bent at a right angle at location 100 so as to be insertable into the rear opening 16 of the lug 15.

two shoulders 65 or stubs may be placed near the base of the tab and bent at location 95. Configurations without the stubs are also possible. FIG. 5B is a rear view of the crimpable lug 15 showing the tang 70 of the connector 50 inserted into the rear opening 16 thereof. The stubs 65 are spaced with respect to the tang 70 such the shell 19 of the crimpable lug 16 can be positioned therebetween after bending. This may aid in aligning the connector 50 with the crimpable lug 15 during the captivation process, and may offer support against rotation of the connector 50 with respect to the axis of the battery cable during connector during mating and use.

The cable 12 and connector 55 may be inserted into the crimpable lug 15 and the assembly crimped using conventional crimping or swaging tools.

FIG. 6 illustrates a connector 55 that has been bent at a right angle at location 90 so as to be insertable into the rear aperture of the lug 15. In this example the shoulders 65 are not provided.

FIGS. 7A and B are two views of the lug 15 with the cable 12 inserted through the rear aperture 16. FIG. 7 A is a side cross section view showing the tang 70 captivated between the cable 12 and the inner surface of the barrel 19 of the crimpable lug 15 and the cable end 12. FIG. 7B shows a view of the tab component 50 in a bent configuration, positioned in the aperture 16 of the crimpable lug 15. The tang 70 may be inserted prior to or subsequent to the insertion of the cable 12. The cable 12 is often fitted with an insulated jacket 13 which is removed along the portion inserted into the lug 15. The lug 15 has a hole 17 in a flattened end 18 thereof which may be used to captivate the lug 15 to the battery terminal.

The length of the flat tang portion 70 may be selected so as to extend sufficiently far into the lug shell so that, when the assembly is crimped, the flat tang portion 70 contacts at least two of the lays of the cable. The tang 70 may have corrugations (not shown) so as to better enable conforming to the cable 12 when captivated thereto. The multiple contact points between the tang 70 and the cable 12 serve several purposes. The larger the contact area, the lower the resistance, and the more accurate a measurement that can be made. Also, the mechanical resistance of the component 50 to being pulled out of the crimpable lug 15, or to shift in alignment with respect to the crimped location is reduced. Too short a length would make for a less reliable connection. A number of sizes of tab component 50 may be available to use with differing cable diameters and lug dimensions.

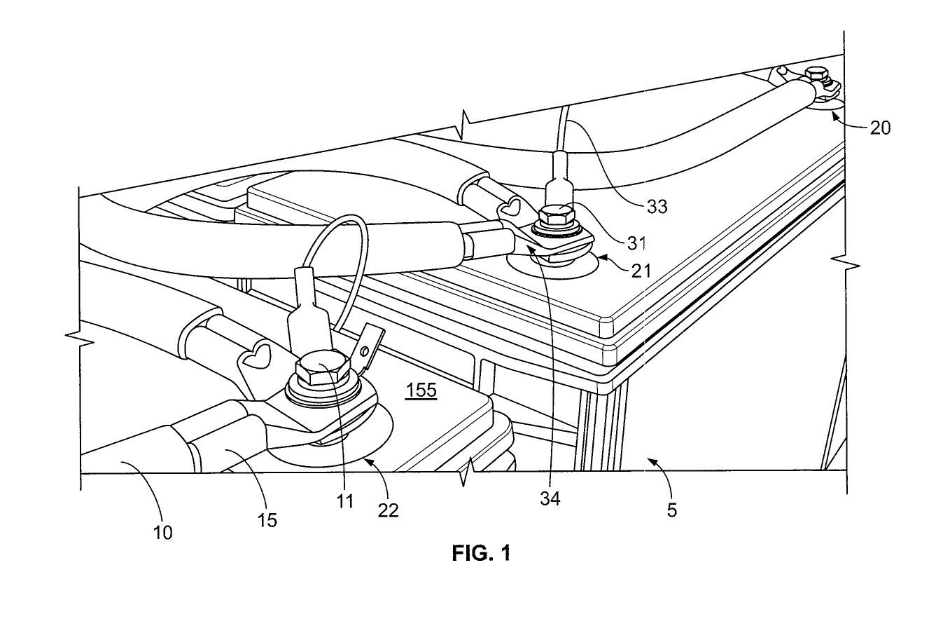

FIG. 8 shows a version of tab component 80 which is similar to component 50 and having a similar use, but having two tab portions 55, providing connectivity corresponding to that shown in the left-hand terminal of FIG. 1, while providing a desired angular and circumferential spacing between the two tab terminals 55.

By suitably sizing the length of the flat tang portion 70 with respect to the depth with which it may be inserted into the rear opening of crimpable lug 15, a series of such connectors 50 may be designed for a wide range of application.

While the flat tang portion 70 is shown as having a uniform width, other configurations may be fabricated having a broader or narrower width as the tang extends into the crimpable lug 15.

While methods disclosed herein have been described and shown with reference to particular steps performed in a particular order, it will be understood that these steps may be combined, sub-divided, or reordered to from an equivalent method without departing from the teachings of the present invention. Accordingly, unless specifically indicated herein, the order and grouping of steps is not a limitation of the present invention.

It is therefore intended that the foregoing detailed description be regarded as illustrative rather than limiting, and that it be understood that it is the following claims, including all equivalents, that are intended to define the spirit and scope of this invention.

What is claimed is:

1. A connector for use with a lug, comprising:
a tab sized and dimensioned to mate with a female push-on connector; and
a tang having a length sufficient to enable the tang to be captivated between a wire and an inner surface of the lug.

2. The connector of claim 1, wherein a bend is formed in the tang such that the tab makes an angle of between about 15 and about 90 degrees with the tang.

3. The connector of claim 2, wherein the angle is approximately 50 degrees.

4. The connector of claim 1, further comprising a pair of stubs attached to the tab at a position proximal to a join of the tang and tab, spaced from the tang by a distance approximately greater than a thickness of a shell of the lug.

5. The connector of claim 4, wherein, when the tang has about a 90 degree bend at the join of the tab and the tang, the stubs are disposable opposite an outside surface of the shell of the lug and the tang is disposable opposite an inside surface of the shell of the lug.

6. The connector of claim 5, wherein the tab has a further bend between the about 90 degree bend tang and the end of the tab distal from the tang, so that the distal end of the tab is oriented at an angle other than about 90 degrees from the axis of the cable, when in an installed position, and the length of the tab between the further bend and the distal end of the tab is sufficient to mate with a conforming configuration of mating connector.

7. The connector of claim 1, when the tang has an about 90 degree bend at the join of the tab and the tang and the tab has a further bend between the about 90 degree bend and the end of the tab distal from the tang, so that the distal end of the tab is oriented at an angle other than 90 degrees from the axis of the cable, when in an installed position, and the length of the tab between the further bend and the distal end of the tab is sufficient to mate with a conforming configuration of mating connector.

8. The connector of claim 1, wherein two tabs are formed such that a first tab and a second tab are spaced apart and joined to the tang by a surface formed therebetween.

9. A connector assembly, comprising:
a lug;
a cable; and
a connector for use with the lug, comprising:
a tab sized and dimensioned to mate with a female push-on connector; and
a tang having a length sufficient to enable the tang to be captivated between the cable and an inner surface of the lug.

10. The connector of claim 9, wherein a bend is formed in the tang such that the tab makes an angle of between about 15 and about 90 degrees with the tang.

11. The connector of claim 10, wherein the angle is approximately 50 degrees.

12. The connector of claim 9, further comprising a pair of stubs attached to the tab at a position proximal to a join of the tang and tab, spaced from the tang by a distance approximately greater than a thickness of a shell of the lug.

13. The connector of claim 12, wherein, when the tang has about a 90 degree bend at the join of the tab and the tang, the stubs are disposable opposite an outside surface of the shell of the lug and the tang is disposable opposite an inside surface of the shell of the lug.

14. The connector of claim 13, wherein the tab has a further bend between the about 90 degree bend tang and the end of the tab distal from the tang, so that the distal end of the tab is oriented at an angle other than about 90 degrees from the axis of the cable, when in an installed position, and the length of the tab between the further bend and the distal end of the tab is sufficient to mate with a conforming configuration of mating connector.

15. The connector of claim 9, when the tang has an about 90 degree bend at the join of the tab and the tang and the tab has a further bend between the about 90 degree bend and the end of the tab distal from the tang, so that the distal end of the tab is oriented at an angle other than 90 degrees from the axis of the cable, when in an installed position, and the length of the tab between the further bend and the distal end of the tab is sufficient to mate with a conforming configuration of mating connector.

16. The connector of claim 9, wherein two tabs are formed such that a first tab and a second tab are spaced apart and joined to the tang by a surface formed therebetween.

17. A method of manufacturing a connector assembly, comprising:
providing:
a lug;
a cable having an exposed cable portion;
a connector for use with the lug, comprising:
a tab sized and dimensioned to mate with a female push-on connector; and
a tang having a length sufficient to enable the tang to be captivated between the cable and an inner surface of the lug;
inserting the exposed cable portion into a rear opening in the lug, the rear opening of the lug being at an opposite end of the lug from a portion of the lug adapted to be captivated to an electrical terminal;
inserting the connector into the rear opening of the lug such that the tang of the connector is disposed between an inner surface of the lug and the exposed cable portion; and
captivating the exposed cable portion and the connector to the lug.

18. The method of claim 17, wherein captivating the cable and the connector to the lug comprises at least one of crimping the lug at a portion containing the exposed cable portion inserted into the lug and tang; or, soldering the exposed cable portion and the tang to the inner surface of the lug.

19. The method of claim 17, further comprising:
bending the connector such that the tab and the tang to form approximately a right angle.

20. The method of claim 19, further comprising:
bending the tab at a location between the tang and a free end of the tab so that the free end of the tab is oriented at an angle of other than the angle between the tab and the tang.
